(19) United States
(12) Patent Application Publication
(10) Pub. No.: US 2024/0167979 A1
(43) Pub. Date: May 23, 2024

(54) METHOD FOR FORMING A UNASSEMBLED ELECTROPHORESIS GEL CASSETTE

(71) Applicant: SMOBiO Technology, Inc., Hsinchu City (TW)

(72) Inventor: KUAN-LIN LEE, Hsinchu City (TW)

(73) Assignee: SMOBiO Technology, Inc., Hsinchu City, TW (TW)

(21) Appl. No.: 18/423,340

(22) Filed: Jan. 26, 2024

Related U.S. Application Data
(63) Continuation-in-part of application No. 16/699,141, filed on Nov. 29, 2019, now abandoned.

(51) Int. Cl. G01N 27/453

(52) U.S. Cl. CPC G01N 27/453

(57) ABSTRACT

An improved method for forming a unassembled electrophoresis gel cassette, including following steps: a first injecting step for forming a first plate, and a second injecting step for forming a second plate, in which a plurality of bottom protrusions and/or a plurality of top protrusions are concurrently formed; an engaging step for engaging the convex edges and the concave edges of the two left spacers and the two right spacers when in accommodation; a bonding step for bonding the first plate and the second plate; and a cutting step of cutting off the part lines and the demoulding angles of the bottom sides of the first plate and the second plate in one process to form a smooth and flat peripheral surface.

### CROSS REFERENCE

The pression application is a continuation-in-part (CIP) application of the pending U.S. patent application Ser. No. 16/699,141 filed on Nov. 29, 2019, which is hereby incorporated by reference in its entirety.

### FIELD OF THE INVENTION

The present invention relates to a method for manufacturing an electrophoresis gel cassette, in particular, to an improved method for forming a unassembled electrophoresis gel cassette.

### DESCRIPTION OF PRIOR ART

In the art of manufacturing an electrophoresis gel cassette, some processes are involved in preparing a unassembled electrophoresis gel cassette and some methods are directed to manufacturing an assembled cassette. For example, U.S. Pat. No. 8,128,799B2 discloses in column 3 that “FIG. 3A is a view of the bottom edge 12 of the back plate 14, prior to being welded to the front plate and to being sealed with the sealing tape. The bottom edge 12 of the back plate 14 has an elongated slot-shaped opening 31 that is interrupted by one or more piers 32 or strengthening ribs that add structural stability to the plate and the opening. The opening is the lower terminus of the gel space and exposes the lower end of the gel during electrophoresis. The peripheral surface 33 surrounding the interrupted opening is smooth, flat, and free of discontinuities, and contains no weld lines. Welding is instead performed along the raised lateral edges 34, 35 and the bottom, thickened edge 23”. This patent is complicated in preparing the thickened lower edge 23 of the back plate 14 and the elongated slot-shaped opening and the piers. In additions, it is ignored of the occurrence of smiling effect.

U.S. Pat. No. 4,035,377 discloses in column 5 that “Plates 10, 12, which form a chamber in which a slab 60 of gel is formed, are shown in FIG. 1 with a comb 14 which assists in forming the slab of gel within the chamber”, and in column 7 that “One end of plate 12 (the top as shown in FIG. 1, but “the bottom as shown in FIG. 3) has a member 50 which has been milled to have relatively wide regions 52, which are as thick as the plate portion 16, spaced by projections 54, which are as deep as the strip members 18, for accurately spacing the end of the plate 12 from plate 10 when the plates are assembled for receiving the gel”. As disclosed, this patent is directed to the provisions that” protrusions 54 provided therein are to accurately spacing end of the plate 12 from plate 10″. It has no concerned with avoiding gel leakage or eliminating the smiling effect.

US 2011/0207328A1 discloses in paragraph 52 that “In some embodiments, the divider plate has a series of features, bumps, or posts 240 located along the length of the sides of the plate 204 and along the bottom length of the plate. The posts 240 may protrude from the divider plate 202 and upon attachment or the divider 202 to the retainer plate (204 in FIG. 2B), the posts 240 may connect with the retainer plate.” In this patent application, the posts 240 are provided around the left, the right and the bottom sides, while not on the top sides. It might be functioned partly for eliminating the smiling effect. However, the structure is complicated without considering at all the prevention of leakage while in the gel injection.

Further, it is submitted that a smiling effect is a problem to be solved with the phenomenon and understanding as follows. Pre-formed electrophoretic gel is time-saving and easier to produce accurate and consistent result. To store the pre-formed electrophoretic gel needs to be immersed in a buffer solution. However, the gel will absorb the buffer and result in inflation. Most importantly, the degree of the inflation of gel is different owing to the fixed sites. Gels with no fixation in the middle swelled more while gels with the fixation on both sides swelled less. When the electrophoresis was performed with a partial-swelled gel, the passing electric current in the middle site would be amplified. As a result, the sample would move faster and led to the “smiling band”.

Therefore, it is expected to find an ideal and effective method of forming a unassembled electrophoresis gel cassette so as to overcome all the disadvantages existing in the art.

### BRIEF SUMMARY OF THE INVENTION

The invention is intended to provide a method for forming a unassembled electrophoresis gel cassette aiming on both to avoid leakage of the gel in injection and to eliminate the smiling effect, while adopting simple procedures of plastic moulding during manufacturing.

Further, the invention is intended to overcome the deficiencies encountered in the existing prior art by providing the following advantages, (a) adopting a low cost technique to manufacture two plastic plates, including an upper plate (a first plate), and a lower plate (a second plate), while not requiring high precision, and (b) while assembling the two plastic plates, requiring no much time to proceed with a perfect alignment, in addition to not requiring high cost, and continuing such a proceeding till the last cutting step, thereby to form a perfect smooth and flat peripheral surface at the bottom side, in which the perfect smooth and flat surface is an extremely important foundation of preventing from leakage of the gel during gel injection.

The improved method for forming a unassembled electrophoresis gel cassette of the invention comprises the following steps: a first injecting step for forming a first plate, and a second injecting step for forming a second plate, in which a plurality of bottom protrusions and/or a plurality of top protrusions are concurrently formed with the first plate or the second plate, with each injecting step using a simple plastic moulding process, wherein the first plate and the second plate respectively comprise a top side, a bottom side, a left side with a left spacer, a right side with a right spacer, a first surface and a second surface, and the left spacer on the first plate and the left spacer on the second plate, as well as the right spacer on the first plate and the right spacer on the second plate, are respectively provided with a convex edge and a corresponding concave edge for up and down accommodation, and wherein the bottom sides of the first plate and the second plate are demoulded after injection with rough and unflat surfaces having parting lines and demoulding angles; an engaging step for engaging the convex edges and the concave edges of the two left spacers and the two right spacers when in accommodation; a bonding step for bonding the first plate and the second plate via welding the plurality of bottom protrusions and/or the plurality of top protrusions, thereby to assemble the first plate and the second plate to form an unassembled electrophoresis gel cassette; and a cutting step of cutting off the part lines and the demoulding angles of the bottom sides of the first plate and the second plate in one process to form a smooth and flat peripheral surface at the bottom sides of the first plate and the second plate for the unassembled electrophoresis gel cassette, thereby avoiding leakage of electrophoresis gel when in gel injection, while eliminating a smiling effect via provisions of the bottom protrusions and/or the top protrusions.

### BRIEF DESCRIPTION OF THE DRAWINGS

FIG. 1 shows a flow chart for performing an improved method for forming a unassembled electrophoresis gel cassette according to the invention.

FIG. 2 shows an exploded view of the unassembled electrophoresis gel cassette according to the invention.

FIG. 3 shows a schematic drawing for a bonding step according to the invention.

FIG. 4 shows one embodiment that the electrophoresis gel cassette according to the invention comprises three bottom protrusions.

FIG. 5 shows one further embodiment that the electrophoresis gel cassette according to the invention comprises two protrusions.

### DETAILED DESCRIPTION OF THE INVENTION

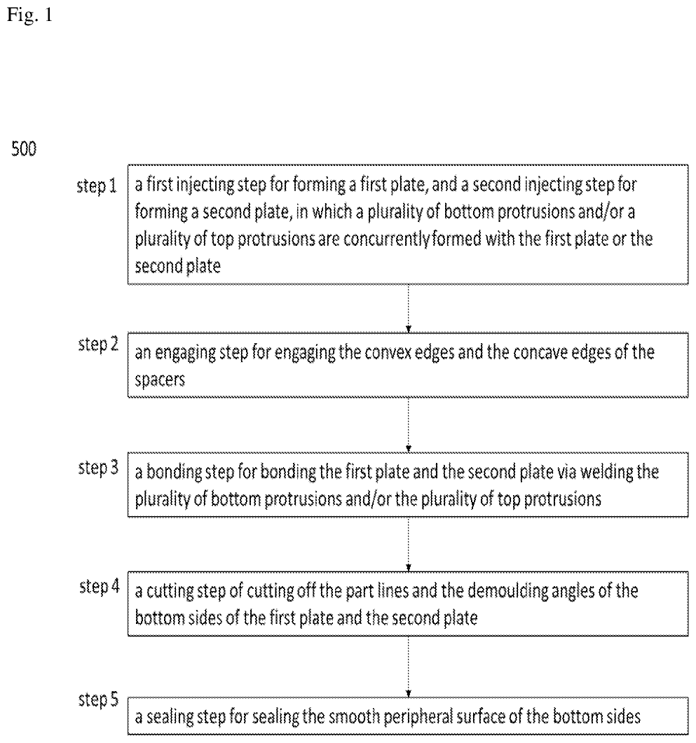

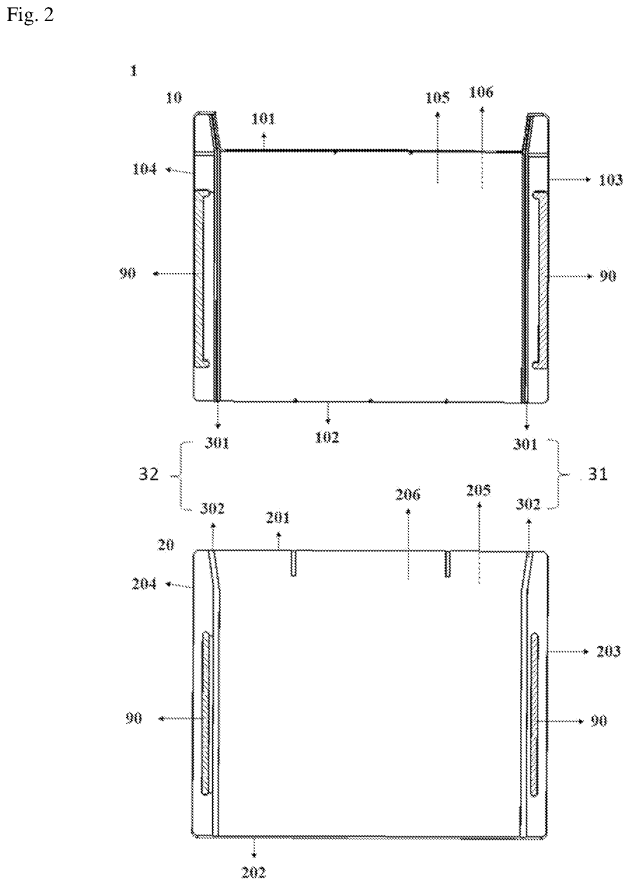

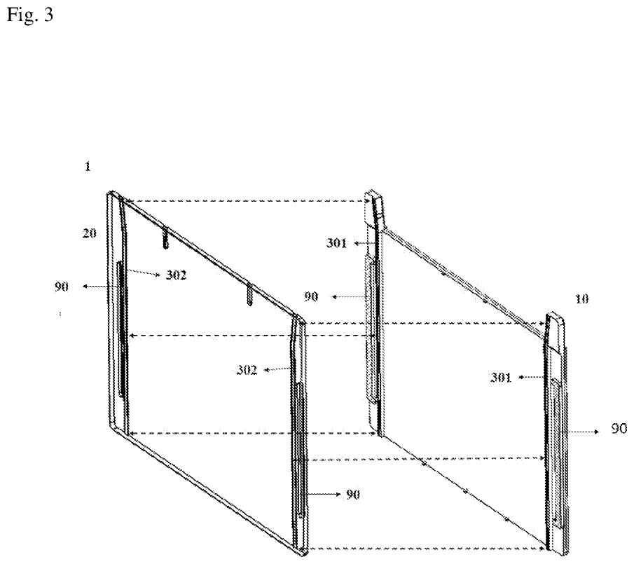

FIG. 1 shows a flow chart for performing an improved method for forming a unassembled electrophoresis gel cassette according to the invention, and FIG. 2 depicts the structure of the unassembled electrophoresis gel cassette of the invention. Please refer to FIG. 1, while referring to FIGS. 2-5 concurrently. The improved method 500 for forming a unassembled electrophoresis gel cassette 1 according to the invention comprises the following steps:

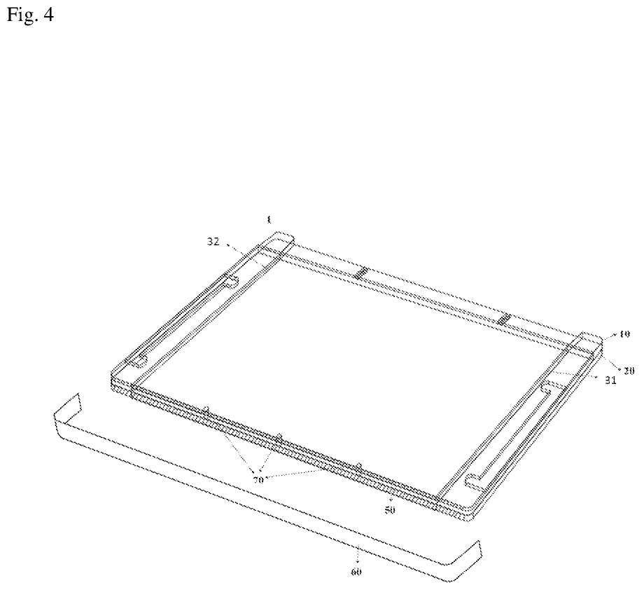

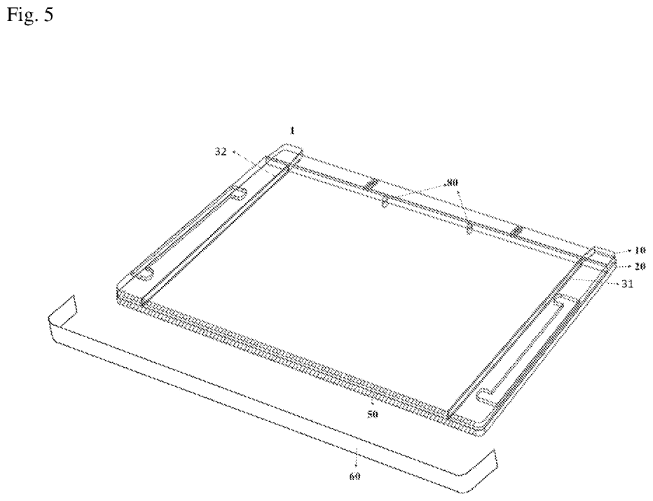

STEP 1: a first injecting step for forming a first plate 10, and a second injecting step for forming a second plate 20, in which a plurality of bottom protrusions 70 (three pieces in FIG. 4) and/or a plurality of top protrusions 80 (two pieces in n FIG. 5) are concurrently formed with the first plate 10 or the second plate 20, with each injecting step using a simple plastic moulding process, wherein the first plate 10 and the second plate 20 respectively comprise a top side 101, 201, a bottom side 102, 202, a left side 104, 204 with a left spacer 32, a right side 103, 203 with a right spacer 31, a first surface 105, 205 and a second surface 106, 206, and the left spacer 32 on the first plate 10 and the left spacer 32 on the second plate 20, as well as the right spacer 31 on the first plate and the right spacer 31 on the second plate 20, are respectively provided with a convex edge 301 and a corresponding concave edge 302 for up and down accommodation, and wherein the bottom sides of the first plate and the second plate are demoulded after injection with rough and unflat surfaces having parting lines and demoulding angles;

STEP 2: an engaging step for engaging the convex edges and the concave edges of the two left spacers 32 and the two right spacers 31 when in accommodation;

STEP 3: a bonding step for bonding the first plate 10 and the second plate 20 via welding the plurality of bottom protrusions 70 and/or the plurality of top protrusions 80, thereby to assemble the first plate and the second plate to form an unassembled electrophoresis gel cassette 1;

STEP 4: a cutting step of cutting off the part lines and the demoulding angles of the bottom sides 102, 202 of the first plate 10 and the second plate 20 in one process to form a smooth and flat peripheral surface at the bottom sides of the first plate and the second plate for the unassembled electrophoresis gel cassette 1, whereby leakage of electrophoresis gel when in the gel injection to be proceeded later is avoided and a smiling effect via bonding of the bottom protrusions 70 and/or the top protrusions 80 is eliminated; and

STEP 5: a sealing step, via providing a sealing element 60, for sealing the smooth peripheral surface of the bottom sides 102, 202 of the electrophoresis gel cassette to prevent from leakage of a liquid matrix of gel to be proceeded in a later processing for injecting the electrophoresis gel.

In the improved method according to the invention, the sealing element 60 is a tape, clay, a glue, a hydrogel, or vaseline.

In the invention, the cutting step makes use of a diamond knife, a laser knife, a water jet, a saw, a high-speed saw blade, a planer, or a high-speed planer.

In the unassembled electrophoresis gel cassette according to the invention, the plurality of bottom protrusions 70 and top protrusions 80 are each disposed in a position at which an electrophoresis sample does not flow through during electrophoresis processing.

Further, the bonding step adopted in the invention makes use of an adhesive or ultrasonic oscillation.

According to the invention, the first plate 10 and the second plate 20 are made from plastic. In addition, the plastic is selected from Polyvinyl Chloride (PVC), Acrylic, Polylactic Acid (PLA), Polystyrene (PS), Polypropylene (PP), Styrene-acrylonitrile copolymer (AS), Acrylonitrile Butadiene Styrene (ABS), Polycarbonate (PC), Polyethylene terephthalate (PET), or Polyethylene (PE).

In addition, in the unassembled electrophoresis gel cassette 1 according to the invention, the first plate 10, the second plate 20, the first spacers 32 and the second spacers 31, and the plurality of top protrusions 80 and the plurality of bottom protrusions 70 are made from glass.

What is claimed is:

1. An improved method for forming a unassembled electrophoresis gel cassette, comprising following steps:
a first injecting step for forming a first plate, and a second injecting step for forming a second plate, in which a plurality of bottom protrusions and/or a plurality of top protrusions are concurrently formed with the first plate or the second plate, with each injecting step using a simple plastic moulding process, wherein the first plate and the second plate respectively comprise a top side, a bottom side, a left side with a left spacer, a right side with a right spacer, a first surface and a second surface, and the left spacer on the first plate and the left spacer on the second plate, as well as the right spacer on the first plate and the right spacer on the second plate, are respectively provided with a convex edge and a corresponding concave edge for up and down accommodation, and wherein the bottom sides of the first plate and the second plate are demoulded after injection with rough and unflat surfaces having parting lines and demoulding angles;
an engaging step for engaging the convex edges and the concave edges of the two left spacers and the two right spacers when in accommodation;
a bonding step for bonding the first plate and the second plate via welding the plurality of bottom protrusions and/or the plurality of top protrusions, thereby to assemble the first plate and the second plate to form an unassembled electrophoresis gel cassette; and
a cutting step of cutting off the part lines and the demoulding angles of the bottom sides of the first plate and the second plate in one process to form a smooth and flat peripheral surface at the bottom sides of the first plate and the second plate for the unassembled electrophoresis gel cassette,
whereby leakage of electrophoresis gel when in gel injection is avoided and a smiling effect via bonding of the bottom protrusions and/or the top protrusions is eliminated.

2. The improved method according to claim 1, further comprising a sealing step, via providing a sealing element, for sealing the smooth peripheral surface of the bottom sides of the electrophoresis gel cassette to prevent from leakage of a liquid matrix of gel.

3. The improved method according to claim 2, wherein the sealing element is a tape, clay, a glue, a hydrogel, or vaseline.

4. The method according to claim 1, wherein the cutting step makes use of a diamond knife, a laser knife, a water jet, a saw, a high-speed saw blade, a planer, or a high-speed planer.

5. The method according to claim 1, wherein the plurality of bottom protrusions and top protrusions are each disposed in a position at which an electrophoresis sample does not flow through during electrophoresis processing.

6. The method according to claim 1, wherein the bonding step makes use of an adhesive or ultrasonic oscillation.

7. The method according to claim 1, wherein the first plate and the second plate are made from plastic.

8. The method according to claim 7, wherein the plastic is selected from Polyvinyl Chloride (PVC), Acrylic, Polylactic Acid (PLA), Polystyrene (PS), Polypropylene (PP), Styrene-acrylonitrile copolymer (AS), Acrylonitrile Butadiene Styrene (ABS), Polycarbonate (PC), Polyethylene terephthalate (PET), or Polyethylene (PE).

9. The method according to claim 1, wherein the first plate, the second plate, the first spacers and the second spacers, and the plurality of top protrusions and the plurality of bottom protrusions are made from glass.
